(19) United States
(12) Patent Application Publication
(10) Pub. No.: US 2005/0135261 A1
(43) Pub. Date: Jun. 23, 2005

(54) ICMP packet generating system for multiple field errors of an IP packet and method therefor

(75) Inventors: Min-jae Lee, Seoul (KR); Yong-jun Lim, Seoul (KR); Hak-goo Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/013,371

(22) Filed: Dec. 17, 2004

(30) Foreign Application Priority Data
Dec. 19, 2003 (KR) 2003-93689

(51) Int. Cl. H04L 1/00

(52) U.S. Cl. 370/241

(57) ABSTRACT

An Internet control message protocol packet generating system includes a field error detecting unit, which detects at least one field error upon reviewing all fields of the Internet protocol packet; and an Internet control message protocol packet generating unit, which records information for the at least one detected field error on the Internet control message protocol packet. The Internet control message protocol packet generating system may further include a field error information storing unit, which sequentially stores information on field errors detected by the field error detecting unit. The Internet control message protocol packet generating unit may generate the Internet control message protocol packet based on field error information stored in the field error information storing unit.

### CROSS-REFERENCE TO RELATED APPLICATION

This application claims the priority of Korean Patent Application No. 2003-93689, filed on Dec. 19, 2003, in the Korean Intellectual Property Office, the disclosure of which is incorporated herein by reference.

### BACKGROUND OF THE INVENTION

1. Field of the Invention

The present invention relates to a system and a method for detecting field errors in an IP packet and generating an ICMP packet, and more particularly, a system and a method for detecting multiple field errors in an IP packet at a time and generating an ICMP packet.

2. Description of the Related Art

An Internet control message protocol (ICMP) is a protocol used to control messages between a transmitter and a receiver, and inform the transmitter of errors. The ICMP is specified in Request for Comments (“RFC”) 792, one of a series of numbered Internet informational documents and standards. The ICMP operates on a network layer together with an Internet protocol (IP). The network layer is one of seven layers of the OSI model. When the receiver detects errors in an IP packet, the receiver encapsulates an ICMP message in the original IP packet and sends an ICMP message packet to the transmitter. In response to the ICMP message packet, the transmitter performs error recovery in order to guarantee reliability of the IP packet.

Internet protocol version 4 (IPv4) utilizes a 32-bit IP address system. The 32-bit IP address system cannot newly allocate an Internet address. Further, there is a need to handle packets for audio and video services in a different manner. Therefore, Internet protocol version 6 (IPv6), utilizing a 128-bit IP address system, has been proposed.

FIG. 1 is a diagram of the structure of an IPv6 packet. An IPv6 packet includes a basic header and payload header. The payload header includes an extension header and a data packet, such as a TCP or UDP packet, for higher layers. The basic header has a total of 40 bytes. 32 bytes of the basic header are allocated to the IP addresses in IPv6. 8 bytes of the basic header are allocated to six fields. In particular, a next header field of the basic header, referred to as NEXT HEADER, is used to identify types of information following the basic header. The extension header is an optional header. The extension header includes option fields indicating the types of extension header and the next header field NEXT HEADER.

An Internet control message protocol version 6 (ICMPv6) protocol is used to transmit error messages and information messages between nodes implementing IPv6 . Internet control message protocol version 4 (ICMPv4) protocols, internet group membership protocols (IGMP), address resolution protocols (ARP), and reverse address resolution protocols (RARP) are currently distributed on the network layer, but they are integrated by using ICMPv6. In addition, since almost all unused types of ICMP messages are removed, ICMPv6 is further simplified.

An ICMPv6 message is attached to the IPv6 packet in its transmission. The ICMPv6 message is identified with a value of the next header field NEXT HEADER, 58, in the IPv6 header. Hereinafter, IP and ICMP are referred to as IPv6 and ICMPv6, respectively, unless otherwise stated.

FIG. 2 illustrates an example of a format of an ICMP message packet. A type field TYPE having a size of 8 bits indicates types of an ICMP message. Since the ICMP message packet is a type of IP packet, as described above, the ICMP message packet includes almost the same basic header as the IP packet except that its next header NEXT HEADER has a value of 58. The ICMP message packet further includes an ICMP message following the basic header.

If the most significant bit of a type field referred to as TYPE is 0, that is, if a value of the type field is in a range of from 0 to 127, the ICMP message is an error message. If the most significant bit of the type field TYPE is 1, the ICMP message is an information message. For example, if the value of the type field is 4, the ICMP message is a parameter error message indicating that an error is detected in the basic or extension header of the IP packet. If the values of the type field TYPE are 128 and 129, the ICMP messages are an echo request message and an echo reply message, respectively, used to implement pings for determining whether or not the IP packet can reach a destination node. Since the type field TYPE has a value of 4 in FIG. 4, it can be understood that the ICMP message packet is a parameter error message.

A code field referred to as CODE having a size of 8 bits indicates details of the ICMP message. For example, when the ICMP message is the parameter error message, parameter errors in the ICMP message are classified in detail according to a value of the code field CODE. The parameter errors include a header field error (CODE=0), an unrecognized next header error (CODE=1), an unrecognized IPv6 option error (CODE=2), and so on.

A checksum field CHECKSUM having a size of 16 bits is used to detect errors in the ICMP message and partially in the IPv6 message.

In addition, when the ICMP message is the parameter error message, the ICMP message includes a pointer field POINTER used to identify a position where an error is detected in the original IP packet, as shown in FIG. 2. Finally, an erroneous IPv6 packet causing generation of the ICMP message is positioned following the pointer field POINTER. The transmitter performs error recovery on the erroneous IPv6 packet.

FIG. 3 is a flowchart illustrating a conventional IP packet field error processing method, where, in response to an IP packet, a receiver performs error detecting on fields of headers of an IP packet and transmits ICMP message packets corresponding to errors to a transmitter. When the receiver receives the IP packet (302), the receiver retrieves a version field VERSION of a basic header of the IP packet to determine whether or not a value of the version field VERSION is 6 (304). If the value of the version field VERSION is not 6, the receiver calls an error handling function and generates an ICMP message packet (310). Subsequently, in the same manner, the receiver transmits the ICMP message packet to a transmitter (312). The receiver also determines whether values of the fields of the basic header of the IP packet are recognizable (306 and 308). If the values of the fields are not recognizable, the receiver calls respective error handling functions and generates respective ICMP messages (316 and 320). The receiver transmits the ICMP message packets to the transmitter (316 and 320). In addition, when the received IP packet has an extension header, the receiver also performs error detecting on a next header field NEXT HEADER, and option fields OPTION, etc., and transmits respective ICMP message packets to the transmitter.

In the conventional IP packet field error processing method, every time an error is detected in a field of the received IP packet, the receiver transmits the respective ICMP message packet to the transmitter. Therefore, while it is possible to detect problems in the network, it is impossible to detect errors induced by problems in the system of the transmitter. In addition, when an ill-intended user attacks the network to forge IP packets or makes a denial-of-service (DoS) attack, it is difficult to defend against the attacks. Moreover, the conventional IP packet field error processing method cannot efficiently handle critical problems created in a passage which two or more nodes-share.

In addition, when errors are detected in all the fields of the IP packet, the errors are most likely to be created in a series of copy procedures of a memory in the transmitter rather than the networks. However, in the conventional IP packet field error processing method, when an error is detected in a field, for example, a version field VERSION, of the IP packet, error detecting is not performed on the next fields and an ICMP message packet corresponding to only the version field VERSION is generated and transmitted to the transmitter. The transmitter recognizes that only the version field VERSION has the error. Therefore, the transmitter performs error recovery of the version field VERSION of the IP packet and retransmits a corrected IP packet to the receiver. In response to the corrected IP packet, the receiver performs error detecting in a next field, for example, a payload length field of the corrected IP packet. If there is an error in the payload length field, another ICMP message packet corresponding to the payload length field is generated and transmitted to the transmitter. Therefore, as many ICMP messages packets as the total number of erroneous fields of the IP packet have to be transmitted between the receiver and transmitter. As a result, the two hosts, that is, the receiver and the transmitter, occupy the network for a long time, which can overload the network and/or occupy limited resources of the network. In particular, it is difficult for the transmitter to efficiently perform error recovery on multiple field errors so that the resources of the network are used efficiently.

### SUMMARY OF THE INVENTION

The invention provides an ICMP message packet generating system and a method therefore, in which a receiver generates a single ICMP message packet including information on multiple field errors in an IP packet to reduce the load of a network.

The invention also provides an ICMP message packet generating system and a method therefore in which a receiver generates a single ICMP message packet including information on multiple field errors in an IP packet and a transmitter performs error recovery on the multiple field errors at the same time, to efficiently perform error recovery an error of an IP packet to reduce the load on a network.

The invention also provides an ICMP message packet generating system and a method thereof, where an transmitter is capable of recognizing that there is a problem in its own system by a receiver's generating an ICMP message packet including information on a fact that all fields of an IP packet have errors.

According to an aspect of the invention, there is provided an ICMP message packet generating system for generating an ICMP message packet for field errors of an IP packet received from a transmitter, the system including: a field error detecting unit, which detects at least one field error upon reviewing all fields of the IP packet; and an ICMP message packet generating unit, which records information on the at least one detected field error in the ICMP message packet.

In the first aspect of the invention, the field error detecting unit may detect errors in fields of a basic header and an extension header of the IP packet. In addition, the ICMP message packet generating unit may allocate a pointer field to the ICMP message packet, wherein the pointer field indicates positions of fields corresponding to the at least one detected field error in the IP packet. In addition, the pointer field may include a field indicating that the field itself is a pointer field. In addition, the ICMP message packet generating unit may allocate an error count field to the ICMP message packet, wherein the error count field indicates the number of field errors detected by the field error detecting unit.

In addition, the ICMP message packet generating unit may assign a value to a code field indicating types of the field errors of the IP packet to represent that error detecting has been performed on the all fields of the IP packets.

In addition, when the field error detecting unit detects multiple field errors, the ICMP message packet generating unit may assign a value to a code field indicating types of the field errors of the IP packet to represent that multiple fields have errors. In addition, when the field error detecting unit detects field errors in all the fields of the IP packet, the ICMP message packet generating unit may assign a value to a code field indicating types of the field errors of the IP packet to represent that all the fields have errors.

According to a second aspect of the invention, there is provided an ICMP message packet generating system for generating an ICMP message packet for field errors of an IP packet received from a transmitter, the system including: a field error detecting unit, which detects at least one field error upon reviewing all fields of the IP packet; and an ICMP message packet generating unit, which allocates a pointer field and an error count field to the ICMP message packet, wherein the pointer field indicates positions of fields corresponding to the at least one detected field error in the IP packet, wherein the error count field indicates the number of field errors detected by the field error detecting unit, wherein, when the field error detecting unit detects multiple field errors, the ICMP message packet generating unit assigns a value to a code field indicating types of the field errors of the IP packet to represent that multiple fields have errors.

In another aspect of the invention, when the field error detecting unit detects field errors in all the fields of the IP packet, the ICMP message packet generating unit may assign a value to a code field indicating types of the field errors of the IP packet to represent that all the fields have errors.

According to still another aspect of the invention, there is provided an ICMP message packet generating method of generating an ICMP message packet for field errors of an IP packet received from a transmitter, the method including: detecting at least one field error upon reviewing all fields of the IP packet; and recording information on the at least one detected field error in the ICMP message packet.

Detailed constructions of one aspect of the invention may be used in another aspect of the invention.

According to another aspect of the invention, there is provided an ICMP message packet generating method of generating an ICMP message packet for field errors of an IP packet received from a transmitter, the method including: detecting at least one field error upon reviewing all fields of the IP packet; allocating a pointer field and an error count field to the ICMP message packet, wherein the pointer field indicates positions of fields corresponding to the at least one detected field error in the IP packet, wherein the error count field indicates the number of field errors detected by the field error detecting unit; and when multiple field errors are detected in the detected at least one field error upon reviewing all fields of the IP packet, assigning a value to a code field indicating types of the field errors of the IP packet to represent that multiple fields have errors.

In this aspect of the invention, the method may further include assigning a value to a code field indicating types of the field errors of the IP packet to represent that all the fields have errors when field errors are detected in all the fields of the IP packet.

According to another aspect of the invention, there is provided an ICMP message packet generating system for generating an ICMP message packet for field errors of an IP packet received from a transmitter, the system including: a field error detecting unit, which detects at least one field error upon reviewing all fields of the IP packet; a field error information storing unit, which stores information on the at least one detected field error; and an ICMP message packet generating unit, which generates the ICMP message packet based on at least one field error information stored in the field error information storing unit after the field error detecting unit performs error detecting on the all fields of IP packets.

In this aspect of the invention, when information on multiple field errors is stored in the field error information storing unit, the ICMP message packet generating unit may assign a value to a code field indicating types of the field errors of the IP packet to represent that multiple fields have errors. In addition, when information on a maximum number of detectable field errors is stored in the field error information storing unit, the ICMP message packet generating unit may assign a value to a code field indicating types of the field errors of the IP packet to represent that all the fields have errors.

In addition, the ICMP message packet generating unit may allocate a pointer field to the ICMP message packet, and wherein the pointer field indicates positions of fields corresponding to the detected multiple field errors in the IP packet. In addition, the pointer field may include a field indicating that the field itself is a pointer field.

In addition, the field error information may include information on numbers of the detected field errors, and the ICMP message packet generating unit may allocate an error count field to the ICMP message packet, wherein the error count field indicates the number of field errors detected by the field error detecting unit.

In addition, the ICMP message packet generating unit may assign a value to a code field indicating types of the field errors of the IP packet to represent that error detecting has been performed on the all fields of the IP packets.

In addition, the field error information storing unit may be constructed with a flag register including a plurality of flag bits allocated to the fields of the IP packet, wherein the flag bits indicate whether or not errors are detected in the respective fields. In addition, the flag register may further include error count bits indicating numbers of flag bits representing that errors are detected.

According to still another aspect of the invention, there is provided an ICMP message packet generating method of generating an ICMP message packet for field errors of an IP packet received from a transmitter, the method including: detecting at least one field error upon reviewing all fields of the IP packet; storing information on the at least one detected field error; and generating the ICMP message packet based on at least one field error information stored relating to the at least one detected field error after the field error detecting unit performs error detecting on the all fields of IP packets.

Detailed constructions of a previous aspect of the invention may be employed in this aspect of the invention.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram of the structure of a conventional IPv6 packet;

FIG. 2 is a diagram of the structure of a conventional ICMPv6 message packet for parameter errors of an TPv6 packet;

FIG. 3 is a flowchart illustrating a conventional IP packet field error processing method;

FIG. 4 is a block diagram illustrating an ICMP message packet generating system according to a first embodiment of the invention;

FIG. 5 is a diagram of the structure of an ICMP message packet for multiple field errors according to embodiments of the invention;

FIG. 6 is a diagram of the structure of an ICMP message packet for all the field errors according to embodiments of the invention;

FIG. 7 is a flowchart illustrating an ICMP message packet generating method according to a first embodiment of the invention;

FIG. 8 is a block diagram illustrating an ICMP message packet generating system according to a second embodiment of the invention; and

FIG. 9 is a flowchart illustrating an ICMP message packet generating method according to a second embodiment of the invention.

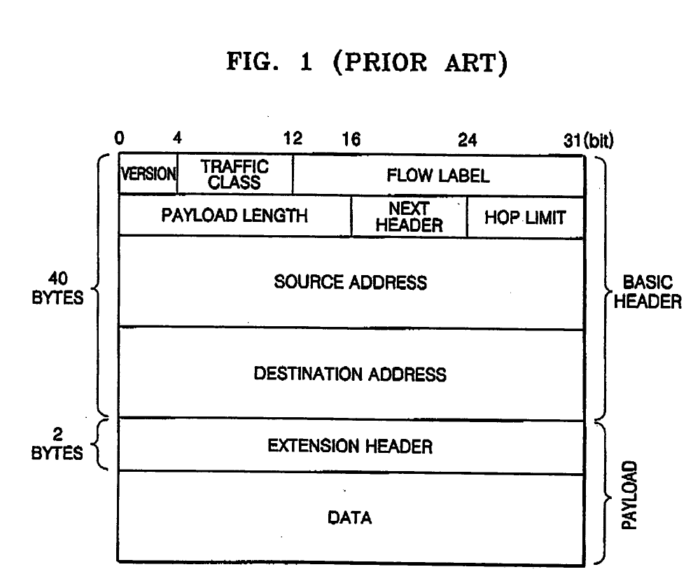

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

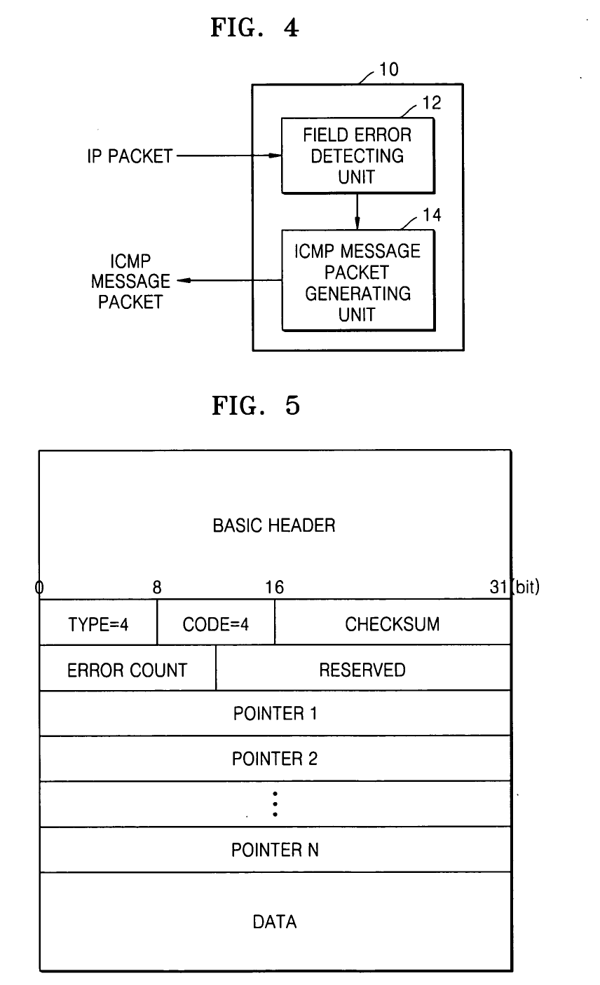

FIG. 4 is a block diagram illustrating an ICMP message packet generating system 10 according to an embodiment of the invention.

The ICMP message packet generating system 10 includes a field error detecting unit 12 and an ICMP message packet generating unit 14. The field error detecting unit 12 performs error detecting on all fields of an IP packet received from a transmitter. The error detecting may be, for example, sequentially performed from a first field of a basic header of the IP packet, that is, from a version field VERSION. In addition to the basic header, the error detecting may be performed on fields of an extension header, when an extension header exists. On the other hand, the error detecting is not performed on currently unspecified fields, for example, a traffic class field TRAFFIC CLASS and a flow label field FLOW LABEL. In addition, the error detecting does not need to be performed on fields such as a hop limit field HOP LIMIT and address fields SOURCE ADDRESS and DESTINATION ADDRESS, which are not objects on which error detection is to be performed.

The field error detecting unit 12 sends information on error-detected fields to the ICMP message packet generating unit 14 in the order in which detection occurs until the error detected is performed or an end field. In response to the error-detected fields, the ICMP message packet generating unit 14 sequentially allocates pointer fields POINTER associated with the error-detected fields to an ICMP message packet, as shown in FIG. 5. As described above, the pointer fields POINTER 1 to POINTER N indicate positions of the error-detected fields in the IP packet.

The ICMP message packet generating unit 14 allocates an error count field ERROR COUNT to the ICMP message packet in order to count the number of pointer fields POINTER 1 to POINTER N. By using the error count field ERROR COUNT, the transmitter can distinguish the pointer fields POINTER 1 to POINTER N from a data field DATA of the ICMP message packet generated. In some cases, in place of the error count field, the pointer fields POINTER 1 to POINTER N may include a field indicating that the field itself is a pointer field.

In FIG. 5, a bit number in the error count field ERROR COUNT is an arbitrary number defined based on a maximum number of fields on which error detection can be performed, hereinafter referred to as error-detectable fields. In addition, a reserved field RESERVED, an unassigned field, may be used in the future.

In FIG. 5, a type field TYPE has a value of 4, indicating that there is a parameter error. In addition, a code field CODE has an arbitrary value other than 0, 1, and 2 in order to indicate that multiple field errors are detected in the IP packet. The code field CODE normally has the values 0, 1, and 2 when multiple errors are not detected. The code field CODE shown in FIG. 5 has a value of 4, indicating that multiple errors are detected.

The receiver generates a single ICMP message packet shown in FIG. 5 and transmits the single ICMP message packet to the transmitter. As a result, it is not necessary for the receiver to repeatedly generate and transmit multiple ICMP message packets every time an error is detected in a field. Accordingly, it is possible to greatly reduce network load. The transmitter can check all the errors in the field of the IP packet at one time. Accordingly, it is possible to efficiently perform error recovery.

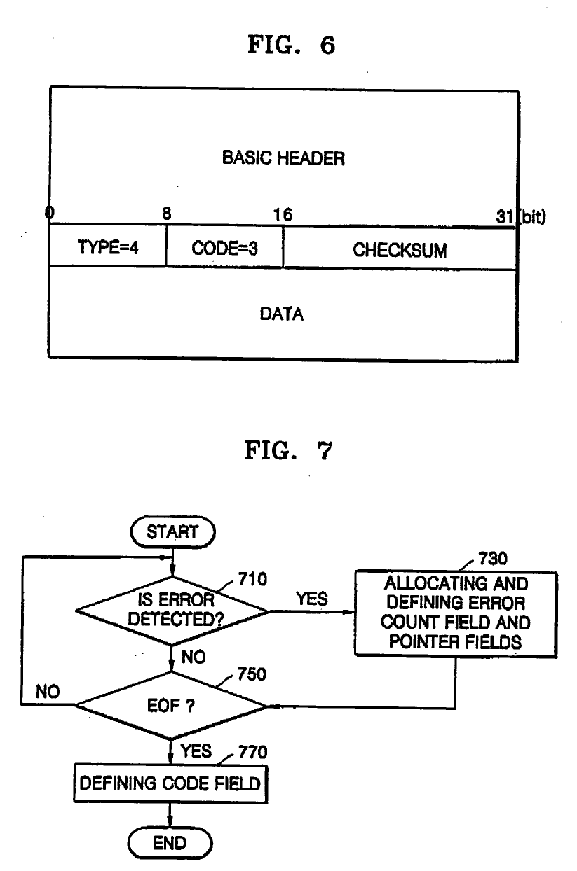

In the aforementioned scenario, errors are obtained by performing error detecting on all fields of the IP packet. However, when errors are detected in all the error-detectable fields of the IP packet, a previously allocated error count field ERROR COUNT and pointer fields POINTER 1 to POINTER N are removed due to a capacity of the ICMP message packet and a network load, as shown in FIG. 6. In addition, a code field CODE has a value of 3, which is different from the code field CODE of FIG. 5, to represent that all the fields of the IP packet have errors. Such format reduces the capacity of the ICMP message packet and the network load. In addition, the transmitter is able to acquire time to check problems in the transmitter as well as the network. Therefore, it is possible to efficiently perform error recovery.

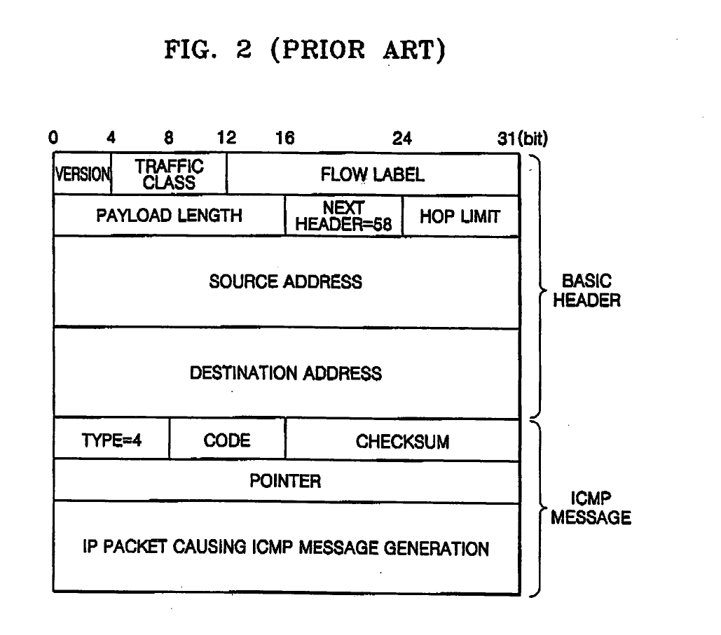

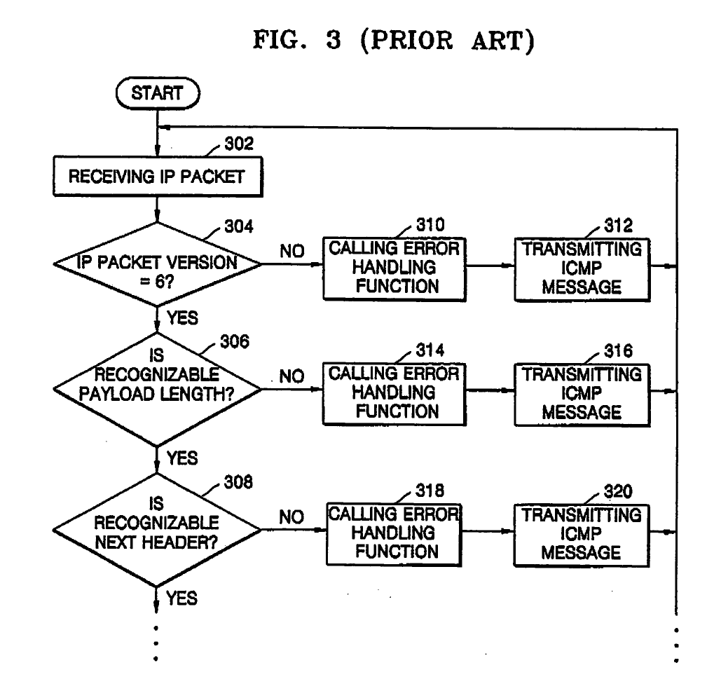

In addition, when only one error is detected in all the fields of the IP packet, a previously allocated error counter field ERROR COUNT is removed and a code field CODE is assigned a value of 0, 1, or 2, according to a type of the error. An ICMP message packet is generated with the conventional format shown in FIG. 2.

However, when the code field of the ICMP message packet is assigned with a value of representing that errors are detected in multiple fields, and an ICMP message packet corresponding to a single field error is generated with the conventional format, a heavy load may be placed on the transmitter. Therefore, in some cases, the code field of the ICMP may be assigned with a value of representing error detecting is performed on all fields of the IP packet and errors are detected in at least one field, and the ICMP message packets may be generated with the same format for the at least one error. In the conventional format, since the transmitter cannot determine whether or not there are errors in fields following an error-detected field indicated in an ICMP message packet, it is difficult for the transmitter to efficiently perform error recovery. According to an embodiment of the invention, when the transmitter receives an ICMP message packet indicating that there is an error in a field, the transmitter can recognize that error detecting is performed on all fields of an IP packet. Accordingly, it is possible for the transmitter to efficiently perform error recovery in comparison with the conventional approach.

FIG. 7 is a flowchart illustrating an ICMP message packet generating method according an embodiment of the invention.

In Operation 710, error detecting is performed on fields of an IP packet received from a transmitter. If errors are detected in fields, in operation 730, pointer fields POINTER 1 to POINTER N are allocated to an ICMP message packet and the positions of the error-detected fields in the IP packet are identified by the pointer fields POINTER 1 to POINTER N. When no error is detected in operation 710, or when operation 730 is completed, it is determined whether or not the procedure reaches an end of field (EOF) of error-detectable fields in operation 750. When the procedure does not reach EOF, the procedure returns to operation 710 and error detecting is performed on the next fields. If the procedure reaches EOF, a code field CODE of the ICMP message packet is defined based on numbers of detected field errors in operation 770 and the procedure for generating the ICMP message packet is completed.

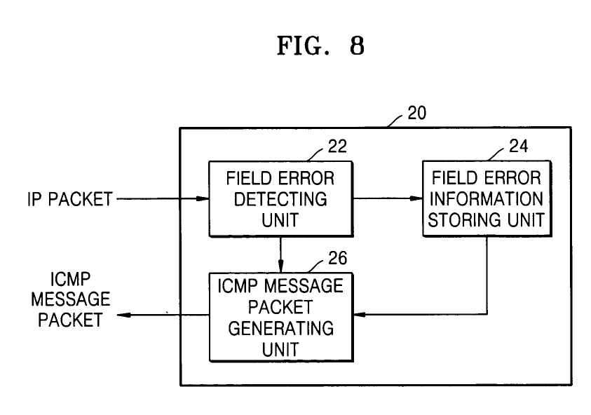

FIG. 8 is a block diagram illustrating an ICMP message packet generating system 20 according to another embodiment of the invention.

The ICMP message packet generating system 20 includes a field error detecting unit 22, a field error information storing unit 24, and an ICMP message packet generating unit 26.

Operations of the field error detecting unit 22 are the same as the field error detecting unit 12 of the above embodiment except that the field error detecting unit 22 sequentially sends information on error-detected fields to the field error information storing unit 24 until error detecting is performed on an end field.

The field error information storing unit 24 stores error-detection position information indicating positions of multiple error-detection fields in an IP packet and error count information indicating the number of detected field errors. When error detecting is performed on all fields of the IP packet, the ICMP message packet generating unit 26 generates an ICMP message packet based on the error-detection position information and the error count information by using the same method shown in FIG. 5. The error count information is recorded in an error count field ERROR COUNT, and the error-detection position information on the multiple error-detection fields is recorded in pointer fields POINTER 1 to POINTER N.

In addition, the field error information storing unit 24 may be formatted with a flag register including a plurality of flag bits corresponding to error-detectable fields of the IP packet. For example, when errors are detected in fields, the corresponding flag bits have values of 1, and if not, they have values of 0, or vice versa. In addition, the flag register may further include error count bits used for counting numbers of binary flag bits of 1. For example, when the ICMP message packet generating unit 26 records the error count bits in the error count field ERROR COUNT, and allocates the pointer fields POINTER 1 to POINTER N to the flag bits of 1 to the ICMP message packet. Headers currently specified in RFC 2463 include eight headers: one basic header, that is, an IPv6 header, and extension headers. In consideration of error-detectable fields in the extension headers. A 32-bit flag register maybe used for storing error-detectable fields in the extension headers. In the future, when error detecting is performed on option fields, a flag register having a larger capacity may be required.

In response to a field error detecting completion signal from the field error detecting unit 22, the ICMP packet generating unit 26 generates an ICMP message packet, as shown in FIGS. 5 and 6, based on the field error information stored in the field error information storing unit 24.

Similarly to a previous embodiment of the invention, in the ICMP message packet generating unit 26, the code field of the ICMP message packet may be assigned with a value of representing errors are detected in multiple fields, and the ICMP message packet corresponding to a single field error may be generated with the conventional format. In addition, a heavy load may be put on the transmitter. Further, in some cases, the code field of the ICMP may be assigned with a value of representing error detecting is performed on all fields of the IP packet and errors are detected in at least one field, and the ICMP message packets may be generated with the same format for the at least one error.

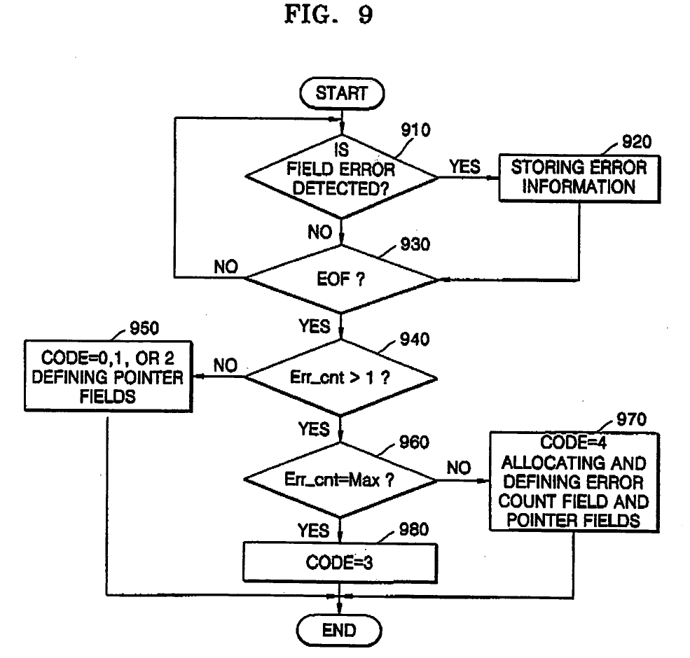

FIG. 9 is a flowchart illustrating an ICMP message packet generating method according to an embodiment of the invention.

In Operation 910, error detecting is performed on fields of an IP packet received from a transmitter. When errors are detected in fields, information on the error-detected fields stored in operation 920 and the procedure goes to operation 930. When no error is detected in operation 910, it is determined whether or not the procedure reaches an end of field (EOF) of error-detectable fields in operation 930. When the procedure has not reached the EOF, the procedure returns to operation 910 and error detecting is performed on the next fields. If the procedure has reached the EOF, it is determined whether the number Err_cnt of field errors stored in operation 920 is larger than 1 in operation S940. When the number Err_cnt is not larger than 1, that is, if Err_cnt=1, the same ICMP message packet as the conventional ICMP message packet shown in FIG. 2 is generated, and the procedure for generating the ICMP message packet is completed.

When the number Err_cnt is larger than 1, it is determined that the number Err_cnt is a maximum number of detectable errors. When the number Err_cnt is the maximum number, the same ICMP message packet (CODE=3) as shown in FIG. 6 is generated in operation 980, and the procedure for generating the ICMP message packet is completed. When the number Err_cnt is not the maximum number, the same ICMP message packet (CODE =4) as shown in FIG. 5 is generated in operation 970, and the procedure for generating the ICMP message packet is completed.

In addition, operations 940 and 950 may be omitted. Further, the code field CODE having a value of 4 in operation 970 indicates that error detecting is performed on the all fields of the IP packet.

According to the invention, error detecting is performed on all fields of an IP packet and a single ICMP message packet is generated based on detected multiple field errors, so that a transmitter can efficiently perform error recovery on a received IP packet.

1. An Internet control message protocol packet generating system for generating an Internet control message protocol packet for field errors of an Internet protocol packet received from a transmitter, the system comprising:
a field error detecting unit, which detects at least one field error upon reviewing all fields of the Internet protocol packet; and
an Internet control message protocol packet generating unit, which records information on the at least one detected field error in the Internet control message protocol packet.

2. The Internet control message protocol packet generating system according to claim 1, wherein the field error detecting unit detects errors in fields of a basic header and/or an extension header of the Internet protocol packet.

3. The Internet control message protocol packet generating system according to claim 1, wherein the Internet control message protocol packet generating unit allocates a pointer field to the Internet control message protocol packet, wherein the pointer field indicates positions of fields corresponding to the at least one detected field error in the Internet protocol packet.

4. The Internet control message protocol packet generating system according to claim 3, wherein the pointer field comprises:
a field indicating that the field is the pointer field.

5. The Internet control message protocol packet generating system according to claim 1, wherein the Internet control message protocol packet generating unit allocates an error count field to the Internet control message protocol packet, and
wherein the error count field indicates the number of field errors detected by the field error detecting unit.

6. The Internet control message protocol packet generating system according to claim 1, wherein the Internet control message protocol packet generating unit assigns a value to a code field indicating types of the field errors of the Internet protocol packet, the value representing that error detecting has been performed on all fields of the Internet protocol packet.

7. The Internet control message protocol packet generating system according to claim 1, wherein, when the field error detecting unit detects multiple field errors, the Internet control message protocol packet generating unit assigns a value to a code field indicating types of the field errors of the Internet protocol packet, the value representing that multiple fields have errors.

8. The Internet control message protocol packet generating system according to claim 1, wherein when the field error detecting unit detects field errors in all of the fields of the Internet protocol packet, the Internet control message protocol packet generating unit assigns a value to a code field indicating types of the field errors of the Internet protocol packet, the value representing that all of the fields have errors.

9. An Internet control message protocol packet generating system for generating an Internet control message protocol packet for field errors of an Internet protocol packet received from a transmitter, the system comprising:
a field error detecting unit, which detects at least one field error upon reviewing all fields of the Internet protocol packet; and
an Internet control message protocol packet generating unit, which allocates a pointer field and an error count field to the Internet control message protocol packet,
wherein the pointer field indicates positions of fields corresponding to the at least one detected field error in the Internet protocol packet,
wherein the error count field indicates the number of field errors detected by the field error detecting unit, and
wherein the Internet control message protocol packet generating unit assigns a value to a code field indicating types of the field errors of the Internet protocol packet, the value representing that multiple fields have errors when the field error detecting unit detects multiple field errors.

10. The Internet control message protocol packet generating system according to claim 9, wherein the Internet control message protocol packet generating unit assigns a different value to the code field indicating types of the field errors of the Internet protocol packet, the different value representing that all of the fields have errors when field errors are detected in all the fields of the Internet protocol packet.

11. An Internet control message protocol packet generating method of generating an Internet control message protocol packet for field errors of an Internet protocol packet received from a transmitter, the method comprising:
detecting at least one field error upon reviewing all fields of the Internet protocol packet; and
recording information on the at least one detected field error in the Internet control message protocol packet.

12. The Internet control message protocol packet generating method according to claim 11, further comprising:
allocating a pointer field to the Internet control message protocol packet when recording information on the at least one detected field error in the Internet control message protocol packet,
wherein the pointer field indicates a position of each field corresponding to the at least one detected field error in the Internet protocol packet.

13. The Internet control message protocol packet generating method according to claim 11, further comprising:
allocating an error count field to the Internet control message protocol packet when recording information on the at least one detected field error in the Internet control message protocol packet,
wherein the error count field indicates the number of detected field errors.

14. The Internet control message protocol packet generating method according to claim 11, further comprising:
assigning a value to a code field indicating types of the field errors of the Internet protocol packet, the value representing that error detecting has been performed on all of the fields of the Internet protocol packet.

15. The Internet control message protocol packet generating method according to claim 11, further comprising:
assigning a value to a code field indicating types of the field errors of the IP packet, the value representing that multiple field errors are detected when multiple field errors are detected upon reviewing all the fields of the Internet protocol packet.

16. The Internet control message protocol packet generating method according to claim 11, further comprising:
assigning a value to a code field indicating types of the field errors of the Internet protocol packet, the value representing that all of the fields have errors when field errors are detected in all the fields of the Internet protocol packet.

17. An Internet control message protocol packet generating method of generating an Internet control message protocol packet for field errors of an Internet protocol packet received from a transmitter, the method comprising:
detecting at least one field error upon reviewing all fields of the Internet protocol packet;
allocating a pointer field to indicate a position of each field corresponding to each the at least one detected field error in the Internet protocol packet;
allocating an error count field to the Internet control message protocol packet to indicate the quantity of field errors detected by the field error detecting unit; and
assigning a value to a code field indicating types of the field errors of the Internet protocol packet, the value representing that multiple field errors are detected from the detecting of the at least one field error upon reviewing all fields of the Internet protocol packet.

18. The Internet control message protocol packet generating method according to claim 17, wherein the method further comprises:
assigning a different value to the code field indicating types of the field errors of the Internet protocol packet when all of the fields of the Internet protocol packet are detected, the value representing that all of the fields have errors.

19. An Internet control message protocol packet generating system for generating an Internet control message protocol packet for field errors of an Internet protocol packet received from a transmitter, the system comprising:
a field error detecting unit, which detects at least one field error upon reviewing all fields of the Internet protocol packet;
a field error information storing unit, which stores field error information on the at least one detected field error; and
an Internet control message protocol packet generating unit, which generates the Internet control message protocol packet based on at least one field error information stored in the field error information storing unit after the field error detecting unit performs error detecting on all fields of Internet protocol packets.

20. The Internet control message protocol packet generating system according to claim 19, wherein when information on multiple field errors is stored in the field error information storing unit, the Internet control message protocol packet generating unit assigns a value to a code field indicating types of the field errors of the IP packet, the value representing that multiple fields of the Internet protocol packet have errors.

21. The Internet control message protocol packet generating system according to claim 20, wherein, when information on a maximum number of field errors is stored in the field error information storing unit, the Internet control message protocol packet generating unit assigns a different value to the code field indicating types of the field errors of the IP packet, the different value representing that all of the fields of the Internet protocol packet have at least one error.

22. The Internet control message protocol packet generating system according to claim 20, wherein the Internet control message protocol packet generating unit allocates a pointer field to the Internet control message protocol packet, and
wherein the pointer field indicates positions of fields corresponding to the detected multiple field errors in the Internet protocol packet.

23. The Internet control message protocol packet generating system according to claim 22, wherein the pointer field comprises:
a field indicating that the field is the pointer field.

24. The Internet control message protocol packet generating system according to claim 22,
wherein the field error information comprises information on a quantity of the detected field errors, and
wherein the Internet control message protocol packet generating unit allocates an error count field to the Internet control message protocol packet, the error count field indicating the quantity of the field errors detected by the field error detecting unit.

25. The Internet control message protocol packet generating system according to claim 19, wherein the Internet control message protocol packet generating unit assigns a value to a code field indicating types of the field errors of the Internet protocol packet, the value representing that error detecting has been performed on all fields of the Internet protocol packets.

26. The Internet control message protocol packet generating system according to claim 19, wherein the field error information storing unit comprises a flag register comprising a plurality of flag bits allocated to the fields of the Internet protocol packet, the flag bits indicate whether errors are detected in the respective fields.

27. The Internet control message protocol packet generating system according to claim 26, wherein the flag register further comprises error count bits indicating a quantity of flag bits representing that errors are detected.

28. An Internet control message protocol packet generating method of generating an Internet control message protocol packet for field errors of an Internet protocol packet received from a transmitter, the method comprising:
detecting at least one field error upon reviewing all fields of the Internet protocol packet;
storing information of the at least one detected field error; and
generating the Internet control message protocol packet based on the stored at least one field error information after the field error detecting unit performs error detecting on the all fields of the Internet protocol packet.

29. The Internet control message protocol packet generating method according to claim 28, further comprising:
assigning a value to a code field indicating types of the field errors of the Internet protocol packet when information of multiple field errors is stored for the at least one detected field error, the value representing that multiple fields have errors.

30. The Internet control message protocol packet generating method according to claim 29, further comprising:
assigning a different value to the code field indicating types of the field errors of the Internet protocol packet when information on a maximum number of detectable field errors is stored for the at least one detected field error, the different value representing that all the fields have errors.

31. The Internet control message protocol packet generating method according to claim 29, further comprising:
allocating a pointer field to the Internet control message protocol packet when generating the Internet control message protocol packet,
wherein the pointer field indicates positions of fields corresponding to the detected multiple field errors in the Internet protocol packet.

32. The Internet control message protocol packet generating method according to claim 31, wherein the pointer field comprises:
a field indicating that the field is the pointer field.

33. The Internet control message protocol packet generating method according to claim 31, further comprising:
allocating an error count field to the Internet control message protocol packet when information on a maximum number of detectable field errors is stored for the at least one detected field error, the error count field indicating a quantity of the field errors detected by the field error detecting unit,
wherein the field error information stored for the at least one detected field error comprises information of the quantity of the detected field errors.

34. The Internet control message protocol packet generating method according to claim 28, further comprising:
assigning a value to a code field indicating types of the field errors of the Internet protocol packet when information of a maximum number of detectable field errors is stored for the at least one detected field error,
wherein the value represents that error detecting has been performed on all of the fields of the Internet protocol packets.

35. The Internet control message protocol packet generating method according to claim 28, the storing of information for the at least one detected field error further comprises:
storing the field error information in a flag register comprising a plurality of flag bits allocated to the fields of the Internet protocol packet,
wherein the flag bits indicate whether or not errors are detected in the respective fields.

36. The Internet control message protocol packet generating method according to claim 35, wherein the flag register further comprises:
error count bits indicating a quantity of flag bits representing that errors are detected.

37. A method of detecting errors in a network protocol packet that is transmitted between a transmitter and at least one receiver, comprising:
performing error detecting on all fields of the network protocol packet;
generating a single network protocol message packet according to the detected errors of the network protocol packet; and
transmitting the generated single network protocol message packet to the transmitter so that error recovery on the network protocol packet is performed.

38. The method of detecting errors in the network protocol packet of claim 37, wherein the error detecting is sequentially performed on all of the fields of the network protocol packet beginning with a header field.

39. The method of detecting errors in the network protocol packet of claim 38, wherein pointer fields associated with positions of the detected errors of the network protocol packet are sequentially allocated in the single network protocol message packet according to the error detecting.

40. The method of detecting errors in the network protocol packet of claim 37, further comprising:
inserting a field code in the network protocol message packet to represent that all of the fields of the network protocol packet have at least one error when at least one error is detected for each field of the network protocol packet; and
transmitting the network protocol message packet to the transmitter to perform error recovery.

41. The method of detecting errors in the network protocol packet of claim 37, further comprising:
inserting a field code in the network protocol message packet to represent that one error is detected upon reviewing all of the fields of the network protocol packet;
setting a value of the field code according to a type of the error; and
transmitting the network protocol message packet to the transmitter to perform error recovery.

42. The method of detecting errors in the network protocol packet of claim 37, further comprising:
inserting a field code in the network protocol message packet to represent that at least one error is detected in at least one field of the network protocol packet when errors are detected in at least one field of the network protocol packet; and
transmitting the network protocol message packet to the transmitter to perform error recovery.

43. The method of detecting errors in the network protocol packet of claim 37, further comprising:
inserting a field code in the network protocol message packet according to the at least one error detected after the error detecting is performed on all fields of the network protocol packet.

44. The method of detecting errors in the network protocol packet of claim 43, further comprising:
setting the field code with a first-type value when errors are detected in multiple fields of the network protocol packet; and
setting the field code with a different value when a single error is detected in one of the fields of the network protocol packet.

45. The method of detecting errors in the network protocol packet of claim 37, further comprising:
allocating an error count to the network protocol message packet indicating the number of detected errors of the network protocol packet.

46. An error detection system for detecting errors in a network protocol packet that is transmitted between a transmitter and at least one receiver, comprising:
an error detection unit to perform error detecting on all fields of the network protocol packet; and
a network protocol message packet generating unit to generate a single network protocol message packet according to the errors detected by the error detection unit and transmit the generated single network protocol message packet to the transmitter so that error recovery on the network protocol packet is performed.

47. The error detection system of claim 46, wherein the error detection unit sequentially performs error detection on all of the fields of the network protocol packet beginning a header field.

48. The error detection system of claim 47, wherein the network protocol message packet generating unit inserts a field code in the network protocol message packet to represent that all of the fields of the network protocol packet have at least one error when at least one error is detected for each field of the network protocol packet.

49. The error detection system of claim 47, wherein the network protocol message packet generating unit inserts a field code in the network protocol message packet to represent that one error is detected upon reviewing all of the fields of the network protocol packet.

50. The error detection system of claim 49, wherein the network protocol message packet generating unit sets a value of the field code according to a type of the error.

51. The error detection system of claim 47, wherein the network protocol message packet generating unit inserts a field code in the network protocol message packet to represent that at least one error is detected in at least one field of the network protocol packet when errors are detected in at least one field of the network protocol packet.

52. The error detection system of claim 47, wherein the network protocol message packet generating unit inserts a field code in the network protocol message packet according to the at least one error detected after the error detecting is performed on all fields of the network protocol packet.

53. The error detection system of claim 52, wherein the network protocol message packet generating unit sets the field code with a first-type value when errors are detected in multiple fields of the network protocol packet and sets the field code with a different value when a single error is detected in one of the fields of the network protocol packet.

54. The error detection system of claim 46, further comprising:
a storage unit to store error information relating to the error detecting performed on all fields of the network protocol packet by the error detection unit.
